(19) United States
(12) Patent Application Publication
(10) Pub. No.: US 2010/0012485 A1
(43) Pub. Date: Jan. 21, 2010

(54) APPARATUS INCLUDING AT LEAST ONE ELECTROLYTIC CELL

(75) Inventors: Claes Berglund, Geneve (CH); Pierre Leitgib, Vesenaz (CH)

Correspondence Address: YOUNG & THOMPSON, 209 Madison Street, Suite 500, Alexandria, VA, 22314, US

(73) Assignee: BULANE SA, GENEVA (CH)

(21) Appl. No.: 12/439,365

(22) PCT Filed: Aug. 8, 2007
(86) PCT No.: PCT/IB07/02284

§ 371 Date: Apr. 27, 2009

(30) Foreign Application Priority Data
Sep. 1, 2006 (CH) 01408/06

(51) Int. Cl. C02F 1/461

(52) U.S. Cl. 204/267; 204/242

(57) ABSTRACT

An electrolytic apparatus that can be immersed in a saline solution, includes at least one electrolytic cell having a body (1) and a cover (2) made of an insulating material; this body contains two power supply electrodes formed by a plate (3) and a rod (3a) manufactured in a single piece. The outer surfaces of the body have snap-coupling formations for assembling a plurality of cells.

This invention has as its object a device that comprises at least one electrolysis cell, in particular for the production, using saltwater or brackish water as a starting material, of a solution for rendering said water potable and disinfecting it, whereby said cell can be used on site in particular in developing countries.

Such devices are known from the document WO/2005/044731 that describes a unit electrolysis cell that comprises a chamber that is formed by two identical molded parts, fitted on one another and containing electrodes that are arranged parallel to one another in this chamber, whereby the two lateral external electrodes are connected by welding to electrical conductors.

The primary drawbacks of such a device are, on the one hand, that it comprises only one electrolysis cell, which limits the production of the solution for rendering water potable and disinfecting it, and, on the other hand, that the welds between the electrical conductors and the electrodes are prone to rapid corrosion, limiting the service life of the device and requiring frequent repair work.

The aim of this invention is the production of a device that comprises at least one electrolysis cell, in particular for the on-site production of a solution for rendering the water potable and for disinfecting it, which eliminates the drawbacks of the devices as described in the above-mentioned document, thus making it possible to increase the duration of use of the device without repair work and to produce units that have a high capacity for production of said solution.

This invention has as its object a device that comprises at least one electrolysis cell that comprises the characteristics that are listed in Claim 1.

By way of example, the accompanying drawing diagrammatically illustrates an embodiment of an electrolysis device according to this invention.

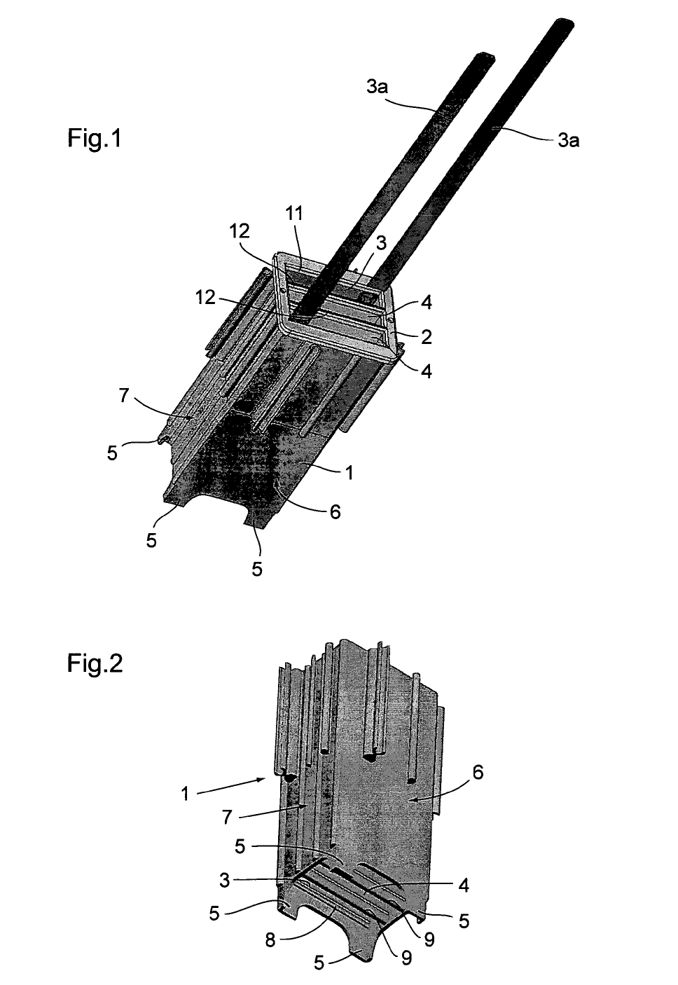

FIG. 1 is a perspective view of an electrolysis cell of the device according to the invention.

FIG. 2 is a perspective view of the body of the housing of an electrolysis cell as illustrated in FIG. 1.

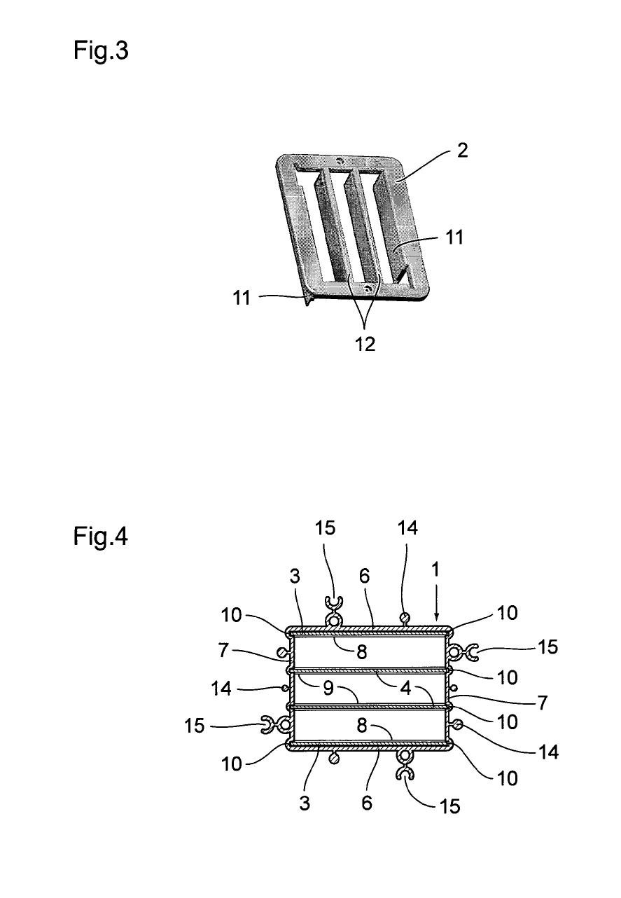

FIG. 3 is a perspective view of the cover of the housing of an electrolysis cell as illustrated in FIG. 1.

FIG. 4 is a transverse cutaway view of the body of the housing of the electrolysis cell.

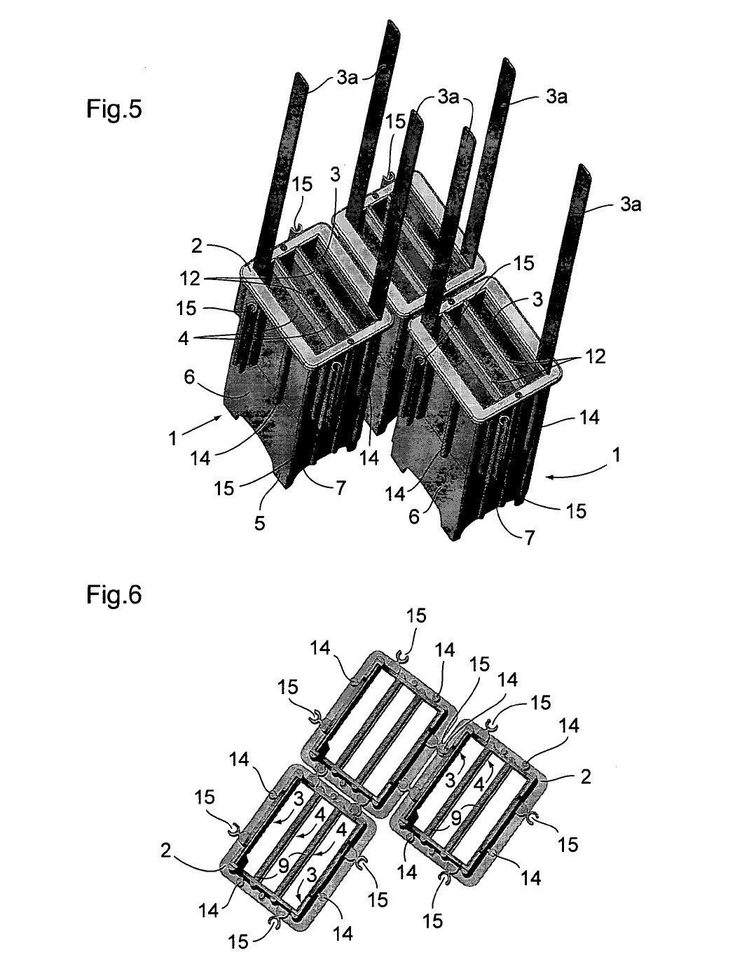

FIG. 5 is a top perspective view of an electrolysis device according to the invention that comprises three electrolysis cells as illustrated in FIG. 1.

FIG. 6 is a bottom view of the electrolysis device that is illustrated in FIG. 5.

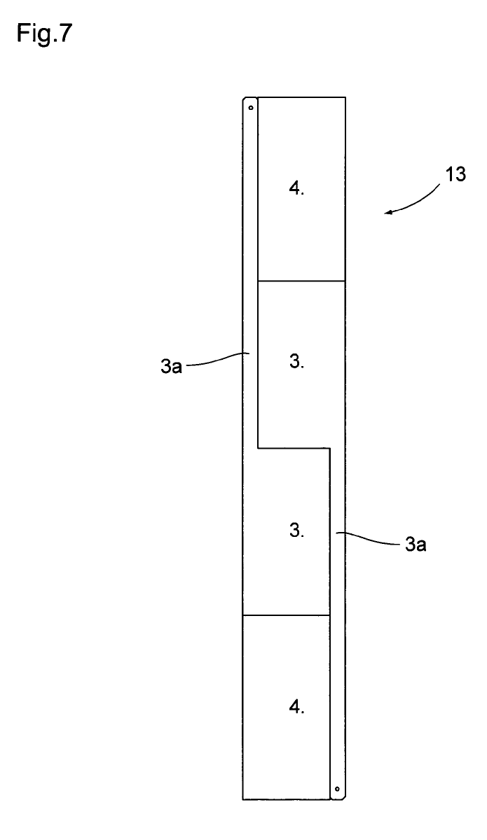

FIG. 7 illustrates the process for cutting the electrodes of an electrolysis cell from a side of suitable material.

The electrolysis device according to this invention for the on-site production—i.e., under difficult conditions within the framework of humanitarian operations for example, and using saltwater or brackish water as a starting material—of a solution for rendering said water potable and disinfecting it comprises at least one, but generally several, electrolysis cells that can be coupled to one another to form a monolithic device. Owing to this adaptable design of the device, its production of a solution for rendering water potable and disinfecting it can be adapted to the requirements. Each electrolysis cell of the electrolysis device is constituted like the one that is illustrated in FIG. 1 and that will be described below.

Each electrolysis cell consists of a shell or housing that has a body 1 and a cover 2, as well as power supply electrodes 3 and intermediate electrodes 4.

The body 1 of the shell of the electrolysis cell comes in the form of a tubular parallelepiped that is open at its two ends. The lower part of this body 1 comprises feet 5 while its upper end is flat. In the embodiment that is illustrated, this parallelepipedic body comprises two pairs 6, 7 of lateral walls that face one another two by two, whereby the width of the walls of one of the pairs 6 is greater than that of the other pair 7.

The upper face of the body 1 of the shell or housing is flat and receives the cover 2, which is secured in its operating position by gluing, bonding or any other means. This shell that is formed by a body 1 and cover 2 is made of electric-insulating material, for example plastic.

Close to its lower end that comprises the feet 5, the body 1 of the shell comprises stops 8 that project from the inside faces of the walls 7 of this body and crosspieces 9 that connect the walls 6 of the body 1 parallel to the walls 7 of this body. The inside faces of the walls 7 of the body 1 of the shell comprise longitudinal grooves 10 in which the electrodes 3, 4 are inserted at the top of the body 1 until coming to rest against the stops 8 and the crosspieces 9. The cover 2 comprises holding slats 11, 12 that come into contact with the upper segments of the electrodes 3, 4 in operating position to keep the latter in place in the shell.

The power supply electrodes 3 comprise rods 3a that came from a single production part with the plate 3 of these power supply electrodes, so as to prevent any welding or connection that would be embedded in the electrolyte in the operation of the electrolysis cell.

These electrodes 3, 4, generally made of titanium, are obtained from various manufacturers (De Nora, Permascand) and are cut into a side of material 13 (FIG. 7) so as to prevent any falling off of raw material, since the latter is relatively expensive. The L shape of the power supply electrodes 3, 3a makes it possible to prevent any welding or connection between the plates 3 and the rod 3a, and the free end of the rods 3a is shaped so as to be able to be connected directly to standard connectors, for example of the “faston” type of 9.5 mm.

In the illustrated example, the electrolysis device consists of four titanium electrodes 3, 4 that are inserted into a shell that is formed by a body 1 and a cover 2 that is made of injected plastic. The electrodes are inserted into the body 1, and then the cover 2 is secured.

When the electrolysis cell is immersed in a saltwater solution and supplied with electricity, it produces sodium hypochlorite at a rate of at least 10 g/hour. The dimensions of the housing, outside of the connecting elements 3a, are 136×74×63 mm, and the housing has a mass on the order of 170 g with the electrodes.

The device operates with a 12V current source that delivers at least 4 A, such as a car battery or a suitable adapter. It can also be supplied directly by a solar panel of suitable size.

The thus produced electrolysis cell is very compact, sturdy, easy to use, and is not subject to corrosion since no weld or connection is immersed in the electrolyte.

In variants, the cell could have other dimensions and comprise a different number of intermediate electrodes 4, whereby the voltage and the amperage of the current source would be consequently adapted.

The outside faces of the walls 6 and 7 of the electrolysis cell also comprise formations for coupling by ratcheting. Each face of the walls 6, 7 comprises a longitudinal rod 14 that constitutes a male coupling formation and a longitudinal trough 15 that forms a female coupling formation. This rod 14 and this trough 15 extend parallel to one another over at least a portion of the height of the body 1 of the shell.

Using these male coupling formations 14 and female coupling formations 15, several electrolysis cells can be easily assembled by ratcheting, as illustrated in FIGS. 5 and 6 so as to produce an electrolysis device whose production capacity meets the specific needs of a given application.

The primary advantages that the electrolysis device according to the invention offers are:
1. To be able to meet a growing production demand by assembling individual cells together by simple clamping,
2. The optimum use of the titanium sheets for the production of electrodes by reducing the falling off of material and thus limiting the cost of the device,
3. The original cutting of the power supply electrodes in the shape of an L prevents a weld or a connection in the immersed part. This allows a simpler production that prevents the assembly processes and prevents any corrosion reaction at the junction between the plate 3 and the rod 3a of the power supply electrodes,
4. The particular shape of the end of the rod 3a of the power supply electrodes 3 obtained by simple cutting makes possible a connection to standard connectors not requiring any additional connector.

1. Electrolysis device that can be immersed in an electrolyte, in particular a saltwater solution, characterized by the fact that it comprises at least one electrolysis cell that comprises a tubular shell that is open at its ends and that is formed by a body (1) and a cover (2) made of an insulating material, whereby this shell contains two power supply electrodes formed by a plate (3) and a rod (3a) that came from a production part, and by the fact that the outside faces of the shell comprise formations for coupling by ratcheting that make it possible to assemble several cells on one another.

2. Device according to claim 1, wherein it also comprises intermediate electrodes (4) that are arranged in shells (1, 2) that are parallel to one another and to power supply electrodes (3).

3. Device according to claim 1, wherein the free end of the rods (3a) of the power supply electrodes has a shape such that it can accommodate standard connectors to ensure the connection between this electrode and a feed current source.

4. Device according to claim 1, wherein it comprises two power supply electrodes (3) and two intermediate electrodes (4), whereby these four electrodes are obtained by cutting a side of rectangular material, without said material falling off.

5. Device according to claim 1, wherein each cell has a general rectangular or square shape in cross section.

6. Device according to claim 5, wherein two walls that face one another of body (1) of the shell comprise longitudinal grooves (10) in which the electrodes (3, 4) are maintained.

7. Device according to claim 6, wherein the body (1) of the shell, close to its lower end, comprises stop elements (8, 9) that are used as stops in the lower segment of the electrodes (3, 4).

8. Device according to claim 7, wherein the cover (2) comprises holding slats (11, 12) that work with the upper segments of the electrodes (3, 4).

9. Device according to claim 1, wherein the coupling formations of each lateral face of the cell comprise a rod (14) and a trough (15) that can be engaged by clamping in the trough, respectively on the rod of a wall of another electrolysis cell.

10. Device according to claim 1, wherein it comprises a number of individual cells that are coupled to one another by clamping.

11. Device according to claim 2, wherein the free end of the rods (3a) of the power supply electrodes has a shape such that it can accommodate standard connectors to ensure the connection between this electrode and a feed current source.
